(19) United States
(12) Patent Application Publication
(10) Pub. No.: US 2026/0167171 A1
(43) Pub. Date: Jun. 18, 2026

(54) CONTROL APPARATUS FOR A VEHICLE AND METHOD FOR CONTROLLING A VEHICLE

(71) Applicant: ZF Friedrichshafen AG, Friedrichshafen (DE)

(72) Inventors: Bastian Hubracht, Salem (DE); Shruthi Reddy Morsu, Hyderabad (IN); Istvan Hegedus-Bite, Eriskirch (DE); Hubert Bichelmeier, Tettnang (DE); Mohammad Alsharif, Tettnang (DE); Ilker Bagci, Ravensburg (DE); Manuel Kwandt, Hille (DE)

(73) Assignee: ZF Friedrichshafen AG, Friedrichshafen (DE)

(21) Appl. No.: 18/711,432

(22) PCT Filed: Oct. 11, 2022
(86) PCT No.: PCT/EP2022/078164

§ 371 Date: May 17, 2024

(30) Foreign Application Priority Data
Nov. 19, 2021 (DE) 10 2021 213 022.4

(51) Int. Cl. B60W 10/20; B60W 30/095; B60W 50/00; B62D 6/00; G05D 1/00

(52) U.S. Cl. CPC B60W 10/20; B60W 30/095; B60W 30/0953; B60W 50/00; B62D 6/003; B62D 6/008

(57) ABSTRACT

A control unit (102) for a vehicle (100) has a movement module (104) for controlling a movement of the vehicle (100), such that the movement module (104) is made in the form of a first domain. The control unit also has a sensor interface (106) for receiving sensor signals (108), a trajectory interface (110) for receiving a trajectory signal (112) that represents a trajectory of the vehicle (100), and an actuator interface (114) for emitting actuator signals (116) for the control of actuators (118). The movement module includes a determination device (120) for determining the actuator signals (116) using the sensor signals (108) and the trajectory signal (112). In addition, the control unit (102) has a further module (122) in the form of a further domain and connected to the first domain by way of a domain interface (124).

### RELATED APPLICATIONS

This application claims the benefit under 35 U.S.C. § 371 as a U.S. National Phase Application of application no. PCT/EP2022/078164, filed on 11 Oct. 2022, which claims the benefit of German Patent Application no. 10 2021 213 022.4 filed on 19 Nov. 2021, the contents of which are hereby incorporated herein by reference in their entireties.

### FIELD OF THE DISCLOSURE

The present invention relates to a control unit for a vehicle and to a method for controlling a vehicle.

### BACKGROUND

The automotive industry is currently undergoing a radical change of its electric-electronic architecture, or E/E architecture for short. From the classical function-controlling units, the trend is toward a consolidation of functions in fewer control units.

### SUMMARY

Against that background the present invention provides an improved control unit for a vehicle and a better method for controlling a vehicle. Advantageous design features emerge from the figures and from the description that follows.

The approach presented here provides a control unit which, besides a main domain for controlling a movement of the vehicle, comprises at least one further domain for controlling another functionality. Advantageously, the combination of a number of domains can result in high efficiency which reduces latency time and even saves energy.

A control unit for a vehicle is proposed, which comprises a movement module for controlling a movement of the vehicle. The movement module is in the form of a first domain and comprises a sensor interface for receiving sensor signals, as well as a trajectory interface for receiving a trajectory signal that represents a trajectory of the vehicle. The movement module also comprises an actuator interface for emitting actuator signals for the control of actuators. In addition, the movement module comprises a determination device for determining the actuator signals, using the sensor signals and the trajectory signals. The control unit comprises a further module which is in the form of a further domain and is connected to the first domain via a domain interface.

The vehicle can be a motor vehicle, for example a passenger car, a truck, or a utility vehicle, for example. The control unit can be a vehicle-internal control unit with an architecture that incorporates a plurality of domains. Thus, the movement of the vehicle can be controlled by the first domain and, for example, a further vehicle function by the further domain. The further domain can, for example, relate to a vehicle energy-management system, a vehicle safety system or an entertainment system in the vehicle. Advantageously, a plurality of further domains can be connected via the domain interface to the first domain. In that way an adaptable multi-domain control unit can be created. Advantageously, for this an open-structured architecture for various domains can be used and “smart” software can be used for interconnecting the domains in a simple manner. Accordingly, in an embodiment at least one of the further domains can be replaced. Each of the further domains can be provided for implementing a further vehicle function. The vehicle functions can for example come under the heading of the driver-assistance system, which can be selected as standard or alternatively individually and implemented in the control unit. The sensor signals can for example come from sensors in the vehicle which, only optionally, can each be used for at least one vehicle function. The actuators can for example be in the form of drives or electric motors or they can be coupled to these. By virtue of determining the actuator signals, advantageously the actuators required for a vehicle function to be carried out can be activated. Advantageously, the control unit can control a number of different vehicle functions and, alternatively, carry them out, so that the number of control units built into the vehicle can be reduced. In that way, in turn, structural space in the vehicle can advantageously be saved and, in addition or alternatively, used for other purposes.

The control unit can comprise an electronic circuit, which can be designed to provide both a functionality of the determination device and also a functionality of the further module. Thus, functionalities of the first domain and of the at least one further domain can be implemented with the help of at least one electronic component used in common, for example a microprocessor. For example, the control unit can have a single printed circuit board on which the functionalities of the first domain and the at least one further domain are implemented. In that way a variety of vehicle functions can be carried out using one control unit. The control unit can then be called a control device, for example surrounded by a housing of its own. Advantageously, the different domains can exchange data between themselves by way of the domain interface. Otherwise than in separately made control units, this enables more rapid data processing.

According to an embodiment, the movement module can comprise a driver interface for receiving a driver's signal for controlling the actuators, and a priority manager. The priority manager can be designed to provide either the actuator signal or the driver's signal at the actuator interface. Advantageously, the movement module can be designed, for example, to control vehicle movements both on the basis of automatically generated instructions and also on the basis of instructions manually issued by a driver. Using the priority manager, it can be decided automatically whether the automatically generated or the manually issued instructions have priority if parallel compliance is impossible or makes no sense. For example, the driver's signal can represent a steering movement desired by the driver, which could for example be carried out using a steering wheel of the vehicle. Using the driver's signal, for example, the actuator can set a steering angle such that the vehicle can travel in the direction desired by the driver. In short, this means that the driver's signal can represent a manual control of the vehicle by the driver.

Furthermore, the sensor interface can be designed to be able to receive sensor signals from sensors such as an environment registering device, a switch, a temperature sensor, a rain sensor, a sensor of a steering actuator, a sensor of a brake actuator and in addition or alternatively a sensor of a chassis actuator. For example, the sensor signals can represent sensor data which, advantageously, can be used as input parameters for safety-relevant vehicle functions. In addition, or alternatively, the sensor signals can represent sensor data that can be used to assist the driver, such as sensor of a parking assistance system or a reversing camera.

In an embodiment the actuator interface can be designed to output the actuator signals to the steering actuator, the brake actuator and in addition or alternatively to the chassis actuator. For example, using the actuator signals those actuators can be controlled which can influence a movement of the vehicle.

The determination device can comprise a sensor device for determining a combined sensor signal from the sensor signals, an optimization device for determining an optimized trajectory signal from the trajectory signal and the combined sensor signal, and a decoding device for determining the actuator signals from the optimized trajectory signal. Advantageously, by means of the determination device and its setup the control unit can assign a higher priority to a vehicle function to be carried out than to other functions, so that for example driving safety can be increased both for the driver of the vehicle and also for other traffic. For example, for that purpose vehicle functions that affect vehicle movements, such as an emergency braking assistance system, can be assigned higher priority than other actions by the driver such as the actuation of an accelerator pedal of the vehicle.

According to an embodiment, the sensor device, the optimization device, and the decoding device can be made with redundancy. Advantageously, by virtue of the redundant formation of the sensor device, the optimization device and the decoding device, the security against failure can be increased.

The determination device can be made using redundant microprocessors. The microprocessors can be in the form of separate cores of an integrated circuit or in separately integrated circuits. Advantageously, in that way the functionality of the determination device can be maintained eve if one of the microprocessors should fail.

Furthermore, the control unit or the movement module can comprise two redundant energy supply interfaces and an energy supply device for supplying the movement module with energy via at least one of the energy supply interfaces. Advantageously, in that way the probability of a system failure can be reduced. Advantageously, the energy supply device can also be used for supplying energy to the at least one further module. In that way the further module too can benefit from the increased security of supply.

In an embodiment, the movement module can comprise a standard supply device, which can be designed to deactivate part of the movement module when the vehicle is at rest. In an embodiment, the movement module can ensure a full range of functions at least until the vehicle has come to rest. When at rest, for example assemblies or functional units that are not needed can be deactivated, for example when the vehicle has been switched off or parked. Advantageously, in that way the energy consumption can be reduced.

The control unit or the movement module can comprise a safety device, which can be connected to the sensor interface, the brake device and the actuator interface. Advantageously, the safety device can be used to ensure more reliable control of the actuators. For example, using the ASIL safety device (Automotive Safety Integrity Level) the relevant requirements can be ensured.

In addition a method for controlling a vehicle is proposed, wherein the method comprises a step of receiving sensor signals by way of a first domain, a step of receiving a trajectory signal that represents a trajectory of the vehicle via the first domain, a step of determining actuator signals using the sensor signals and the trajectory signal within the first domain and a step of emitting actuator signals for controlling actuators via the first domain.

Advantageously, the method can be carried out or controlled using a control unit in a previously mentioned variant.

### BRIEF DESCRIPTION OF THE DRAWINGS

The invention will be described in greater detail with reference to examples illustrated in the attached drawings, which show:

FIG. 1: A schematic representation of a vehicle with a control unit, according to an example embodiment;

FIG. 2: A schematic representation of an example embodiment of a control unit;

FIG. 3: A schematic representation of an example embodiment of a control unit;

FIG. 4: A schematic representation of an example embodiment of a control unit; and

FIG. 5: A flow chart of an example embodiment of a method for controlling a vehicle.

### DETAILED DESCRIPTION

In the description of preferred example embodiments of the present invention that follows, the same or similar indexes are used to denote elements in the various figures that act in similar ways, so that there is no need for repeated descriptions of those elements.

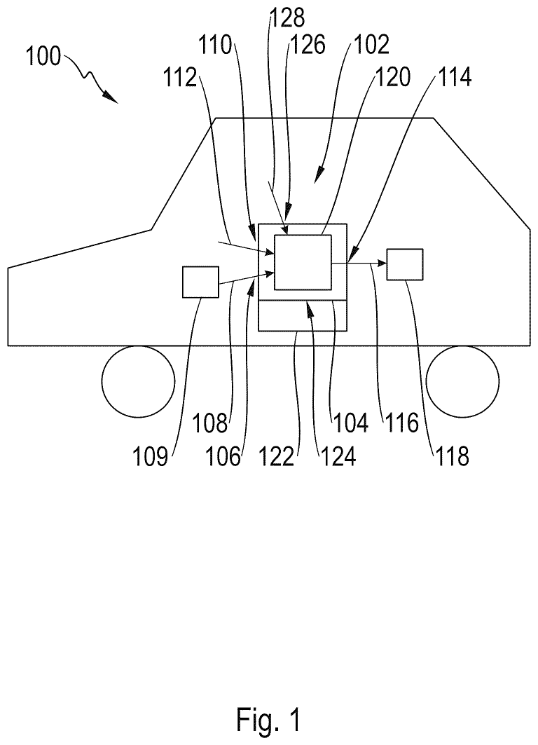

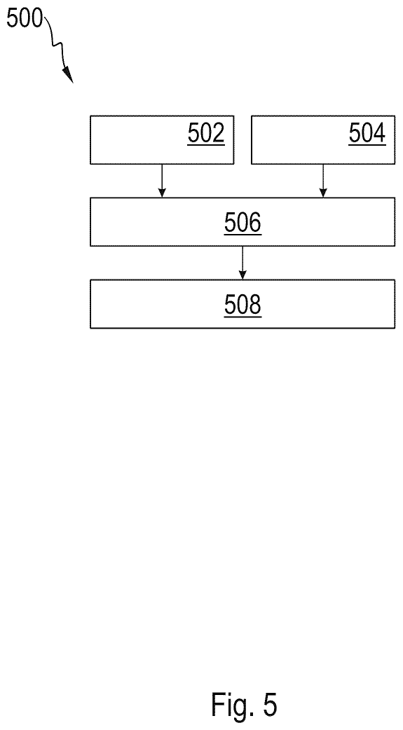

FIG. 1 shows a schematic representation of a vehicle 100 with a control unit 102, according to an example embodiment. In this example embodiment the vehicle 100 is a two-track motor vehicle, or more precisely a passenger car. The control unit 102 can be made, for example, as a control device, or it can be realized in a control device, and is designed to control or carry out a method for controlling the vehicle 100, such as described in FIG. 5.

The control unit 102 comprises for example a movement module 104 for controlling a movement of the vehicle. In this case the movement module 104 is in the form of a first domain within the control unit 102. The movement module 104 comprises a sensor interface 106 for receiving sensor signals 108 which are only optionally generated by a sensor unit 109. The sensor unit 109 is for example in the form of an environment registering device, a switch, a temperature sensor, a rain sensor, a sensor of a steering actuator, a sensor of a brake actuator and/or a sensor of a chassis actuator, or for example comprises at least one of these. Furthermore, the movement module 104 comprises a trajectory interface 110 for receiving a trajectory signal 112 that represents a trajectory of the vehicle 100. The trajectory indicates for example a movement path that lies immediately ahead of the vehicle 100. When the vehicle 100 is driving partially or fully automatically, the trajectory is for example determined automatically. In addition, the movement module 104 comprises an actuator interface 114 for emitting actuator signals 116 for the control of actuators 118. The actuators 118 are for example in the form of a steering actuator, a brake actuator and/or a chassis actuator. Moreover, the movement module 104 comprises a determination device 120 for determining the actuator signals 116 using the sensor signal 108 and the trajectory signal 112. Thus, using the determination device 120 the actuators 118 can be controlled automatically on the basis of the sensor signals 108 and the trajectory signal 112.

According to this example embodiment, the control unit 102 also comprises a further module 122 which is in the form of a further domain and is connected to the first domain by way of a domain interface 124. According to an example embodiment the domains, i.e., the movement module 104 and the further module 122, are realized using one and the same electronic circuit within the control unit 102. Optionally, the control unit 102 has a housing which, for example, accommodates a printed circuit board that carries one or more electronic assemblies required for implementing the functions of the domains.

Only optionally, the movement module 104 also comprises a driver interface 126 for receiving a driver's signal 128 for controlling the actuators 11. This enables the vehicle 100 to be controlled manually by a driver. Optionally, the movement module 104 comprises a priority manager which is designed to send either the actuator signal 116 or the driver's signal 128, prioritized, to the actuator interface 114. The driver's signal 128 is, for example, a signal generated by a driver which is triggered, for example by a steering movement of a steering wheel of the vehicle 100 or, for example, by actuating a vehicle brake or an accelerator pedal of the vehicle 100. The priority manager is for example designed to suppress or delay a command of the actuators 118 initiated by the driver's signal 128, if at least one of the actuator signals 116 is deemed to be more important, or vice-versa. For example, the priority manager is designed to suppress an increase of a rotation speed of a drive unit of the vehicle 100 called for by the driver's signal 128 if one of the actuator signals 116 calls for an activation of a brake device of the vehicle 100 triggered by an emergency braking demand.

According to an example embodiment the control unit 102 contains a number of domains, but at least two domains. The main domain relates to movement of the vehicle (Vehicle Motion, VM). For this, the control unit 102 is designed as a scalable multi-domain ECU with Vehicle Motion as its main domain and an open architecture for various other domains, and ‘smart’ software (SW) for the simple connection of the domains in order to achieve greater efficiency, reduce latency times and even save energy. The ‘smart’ software is used, for example, to create the domain interface 124 and, according to an example embodiment, to enable on the one hand a connection of various further domains to the first domain and on the other hand data exchange between the domains and in particular between the first domain and the at least one further domain. A possible further domain, for example, relates to energy management.

According to an example embodiment, the various domains realized in the control unit 102 include various software modules which are realized using the hardware of the control unit 102 in common.

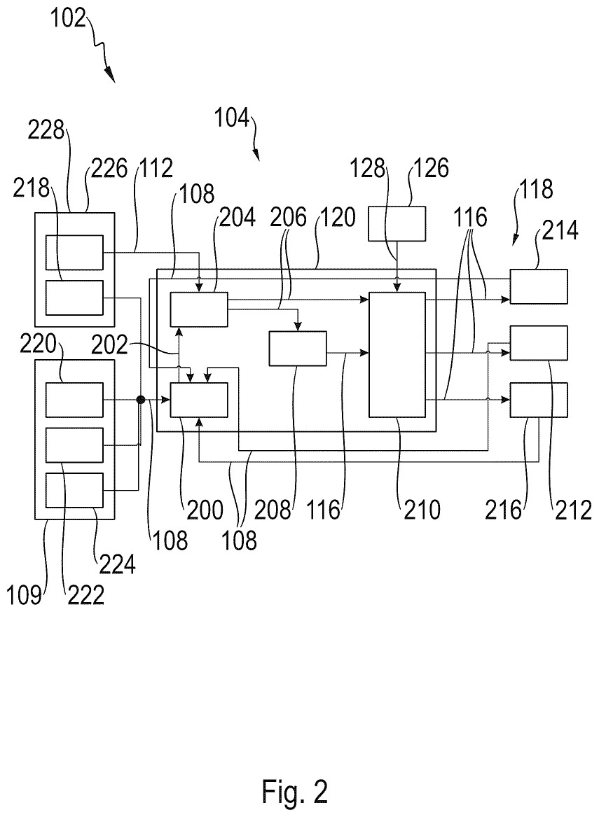

FIG. 2 shows a schematic representation of an example embodiment of a control unit 102. The control unit 102 corresponds or is similar to the control unit 102 described with reference to FIG. 1, and can be realized, for example, for a vehicle as described in FIG. 1.

In this example embodiment as well, the control unit 102 comprises the determination device 120, which in tum comprises a sensor device 200 for determining a combined sensor signal 202 from the sensor signals 108, an optimization device 204 for determining an optimized trajectory signal 206 from the trajectory signal 112 and the combined sensor signal 202, and a decoding device 208 for determining the actuator signals 116 from the optimized trajectory signal 206. Only optionally, the sensor device 200, the optimization device 204 and the decoding device 208 are made with redundancy. In this example embodiment, only optionally the determination device 120 comprises the priority manager 210, which is designed to send either the actuator signal 116 or the driver's signal 128 to the actuator interface and thus to at least one of the actuators 118, so that at least one vehicle function of the vehicle is activated with priority using the optimized trajectory signal 206 and at least one of the actuator signals 118. The actuators 118 are for example in the form of a steering actuator 212, a brake actuator 214 and a chassis actuator 216, which according to an example embodiment are each associated with at least one sensor and which, in addition to the sensor unit 109, send sensor signals 108 to the sensor device 200. For example, such sensor signals 108 show a steering angle of a steering system of the vehicle adjusted by the steering actuator 212, a braking force of a brake unit of the vehicle, or a suspension deflection of a chassis of the vehicle. In addition, or alternatively to sensor signals of an environment registering device 218, the sensor signals 108 of the sensors of the actuators 212, 214, 216 are, for example, a camera, a switch 220, a temperature sensor 222 and/or a rain sensor 224 of the vehicle, generated and received by the sensor device 200.

Expressed in other words, in this example embodiment in particular the movement module 104 of the control device 102 to which FIG. 1 relates is described. In this example embodiment, the further domain is not described since it can be freely selected. For example, by virtue of an ADAS Domain 226 (Advanced Driver-Assistance System) the determination device 120 receives the trajectory signal 112 from a trajectory device 228. For example, the trajectory device 228 is designed to determine or read in the trajectory represented by the trajectory signal 112. Thereupon, in accordance with the driver's wishes (for example regarding energy consumption or driving properties) the optimizing device 204 optimizes the trajectory of the vehicle. Driving properties are adjustable driving modes, such as a comfort mode, a sporty mode, or a terrain mode. The decoding device 208, which for example is also called the trajectory decoder, creates target torques for the actuators 118, for example from waypoints. Using the sensor device 200, for example feedback and information transmission to the optimization device 204 take place using the sensor signal 202. Finally, the priority manager 210 chooses from among various inputs, which are also described as interfaces, which of the inputs has the highest priority. For example, an emergency braking assistant of the vehicle can have higher priority than a driver's wish which is received, for example, by means of the driver's signal 128 via a driver interface 126. For safety reasons, for example the sensor device 200, the decoding device 208 and the priority manager 210 are designed with redundancy.

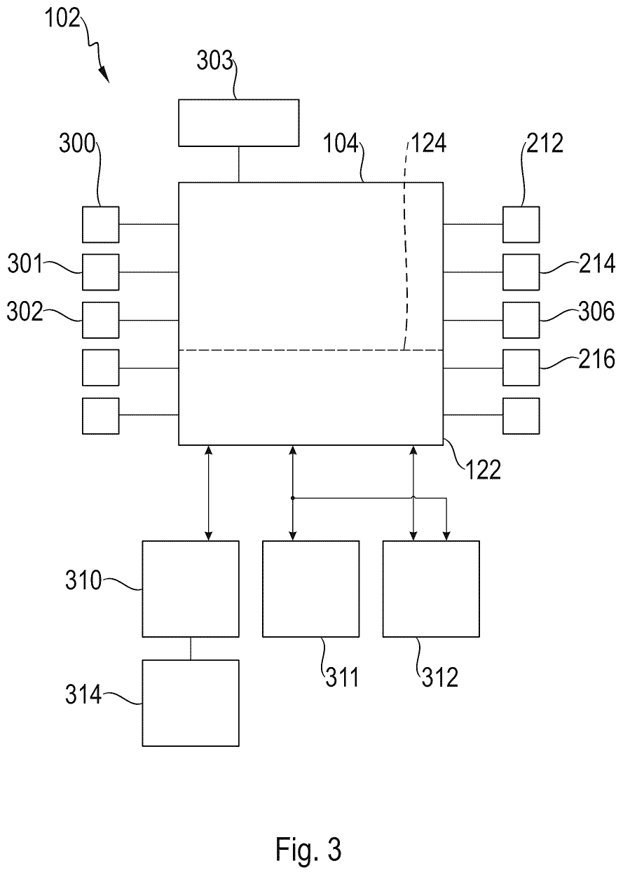

FIG. 3 shows a schematic representation of an example embodiment of a control unit 102. In this example embodiment, compared with the control unit 102 described in FIG. 2 this control unit 102 is represented functionally in order to make clear a domain architecture of the control unit 102. However, the control unit 102 is similar to the control unit 102 described in FIG. 2 and can be used in a vehicle as described for example in relation to FIG. 1. In this example embodiment the control unit 102 comprises the further module 122 as described in FIG. 1, which is in the form of a further domain and is connected by way of the domain interface 124 to the first domain and hence to the movement module 104. The first domain is for example called a Vehicle Motion Domain (VMD) and in accordance with its name, is provided for the control of movement-specific vehicle functions of the vehicle.

On its input side the control unit 102 is connected to sensors of a number of input devices, such as a steering wheel 300, an accelerator pedal 301 and/or a power connection 303 of the vehicle. In an example embodiment the control unit 102 is also connected to an energy supply device 303 such as a battery, which is designed to supply electrical energy for operating the control unit 102. On its output side the control unit 102 is connected to actuators, for example a steering actuator 212, a brake actuator 214, a damper actuator 306 or a chassis actuator 216.

The further module 122 or further domain can for example be chosen freely, so that the further module 122 can be linked with a number of additional domains 310, 311, 312, such as a domain connected with energy management. The additional domains can for example also be coupled with one another and can optionally also be connected, for example, to a Cloud 314.

Expressed in other words, the movement module 104 is responsible for longitudinal, lateral, and vertical movement of the vehicle. The control unit 102, which is also called the Video Motion Domain (VMD) Engine Control Unit (ECU), is connected to sensors as input, in this case for example sensors of the steering wheel 300, the accelerator pedal 301 and/or the power connection 303, and actuators as output, in this case for example the steering actuator 212, the brake actuator 214, the damper actuator 306 or the chassis actuator 216, and to the additional domains 310, 311, 312. For this the control unit 102 comprises a number of communication channels, which for example are called interfaces and are designed for example to communicate with the aforesaid sensors, actuators, and the other domains 310, 311, 312. That takes place, for example, via Ethernet, Controller Area Network (CAN), Local Interconnected Network (LIN) and/or digital input and output.

Advantageously, by way of the domain interface 124 data can be exchanged between the first domain, i.e., the movement module 104, and the other domains 310, 311, 312. In that way, for example, the other domains 310, 311, 312 can access sensor signals of sensors coupled with the control unit 102 or can control actuators coupled to the control unit 102. Optionally, the other domains 310, 311, 312 can be supplied with energy via the power connection 303 of the control unit 102. According to an example embodiment, an electronic circuit of the control unit 102 is used to realize the functionalities both of the movement module 104 and those of the further module 122 and the other domains 310, 311, 312.

In an example embodiment, the control unit 102 is designed to implement ‘smart’ software that enables coupling of the other domains 310, 311, 312. Here, the other domains 310, 311, 312 are represented only as examples. Fewer, or more than the three other domains 310, 311, 312 shown can be coupled.

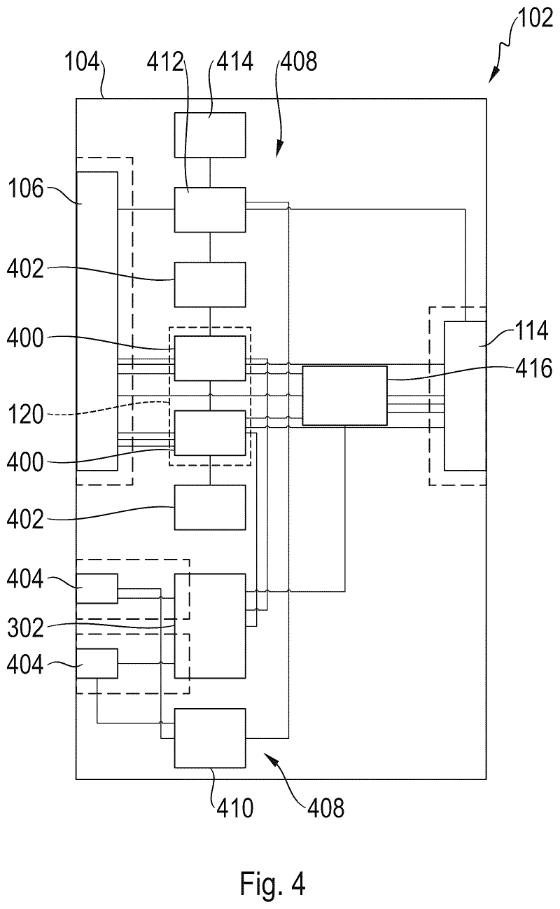

FIG. 4 shows a schematic representation of an example embodiment of a control unit 102. More precisely, in this example embodiment an optional structure of the movement module 104 is shown. The control unit 102 corresponds, or at least is similar to the control unit 102 described in any of FIGS. 1 to 3, or the movement module 104 of the control unit 102 described in at least one of FIGS. 1 to 3.

The control unit 102 comprises the sensor interface 106 via which the sensor signals are received, and the actuator interface 114 via which the actuator signals are generated. In this example embodiment the control unit 102 comprises the determination device 120, which in turn only optionally comprises two redundant microprocessors 400. In this case each microprocessor 400 is coupled to a security unit 402, a so-termed Security Controller. In this example embodiment the microprocessors 400 and thus the determination device 120 are connected between the sensor interface 106 and the actuator interface 114.

According to this example embodiment the movement module 104 also comprises two redundant energy supply interfaces 404 and one energy supply device 302 for supplying the movement module 104 with energy from at least one of the energy supply interfaces 404. In this case, a multi-part standing supply device 408 of the movement module 104 is electrically connected to one of the energy supply interfaces 404. The standing supply device 408 is for example designed to deactivate part of the movement module 104 when the vehicle is at rest, for example parked. For that purpose, for example, the standing supply device 408 comprises an energy supply logic unit 410, a so-termed Standstill Power Supply Logic, and a control element 412 connected to the energy supply logic 410, for example in the form of a further microcontroller. The control element 412 is for example coupled to a further security unit 414, a so-termed Security Controller. For example, the security controllers 402, 414 are designed, if an energy supply should fail, to switch over from a supply voltage to an emergency supply voltage. The movement module 104 also comprises a security device 416, a so-termed Safety Controller, which is connected to the sensor interface 106 and the actuator interface 114.

Expressed in other words, in this example embodiment the control unit 102 provides a redundant voltage supply as security against malfunction. The energy supply device 302 is responsible for the voltage supply and for switching between the voltages provided via the energy supply interfaces 404 if one of the voltages is not available. For example, using the standing supply device 408 in a parked vehicle only those assemblies are supplied which are required in that condition. The other assemblies of the control unit 102, for example, are switched off or separated from the energy supply, whereby the current consumption is reduced, and the life can be extended. Optionally, in an alternative example embodiment a condenser is implemented so that, for example, if the supply voltage is completely cut off control of the vehicle is either transferred to the driver or a safer status of the vehicle such as an emergency braking operation or steering onto a hard shoulder is reached. In that case, only optionally, and if necessary, the condenser can replace a DC line, i.e., one of the energy supply interfaces 404. The standing supply device 408 is also optional and is used for example for a Powerline Communication where a long active lifetime is needed and/or, however, as a so-termed Standby Controller which, for example, hosts functions that are still running when the vehicle is parked, such as access to the vehicle, diagnosis and/or a Real-Time clock. For example, this involves a voltage supply concept for current consumption reduction when a vehicle is parked, wherein the voltage supply is only optionally made with redundancy.

The sensor interface 106 and the actuator interface 114 are also called communication interfaces such as LIN, CAN, CAN-FD, CAN-XL, FR, Ethernet, Powerline Communication, Digital Input and Output or Analog Input. For cyber-security the security controllers 402, 414 are provided with a corresponding memory unit in order to enable secure communication (ComSec), reliable diagnosis (DiagSec) and a secure bootloader (BootSec).

Furthermore, the determination device 120 comprises at least the one but optionally more than one microprocessor 400, which are used among other things for redundancy and lifetime. The functionalities of the microprocessors 400 can for example be realized on a single microprocessor which functionalities, however, run on different cores and such that reciprocal influencing is avoided by means of a storage back-up. Moreover, a degradation is also provided. This takes place, for example, both when the memory “goes to sleep” in several steps and also when the battery voltage is low or in a hazardous situation such as in the even of a crash, so that for example part of the control unit 102, also called the control device, is switched off. For that purpose, a rational division of the functions between the various microprocessors 400 should be carried out. The safety security device 416, for example in the form of a Safety Controller, is provided for fulfilling safety requirements and is also known as Automotive Safety Integrity Level (ASIL). In general, the inputs (IN, DC) and outputs (OUT) are designed as electrically separated.

FIG. 5 shows a flow chart of an example embodiment of a method 500 for controlling a vehicle. The method 500 can for example be carried out by a control unit as has been described for example in any of FIGS. 1 to 4. The method 500 comprises a step 502 of receiving sensor signals via a first domain, a step 504 of receiving a trajectory signal that represents a trajectory of the vehicle via the first domain, a step 506 of determining the actuator signals using the sensor signal and the trajectory signal within the first domain and a step 508 of emitting actuator signals for the activation of actuators via the first domain.

### Indexes

100 Vehicle
102 Control unit
104 Movement module
106 Sensor interface
108 Sensor signal
110 Trajectory interface
112 Trajectory signal
114 Actuator interface
116 Actuator signal
118 Actuator
120 Determination device
122 Further module
124 Domain interface
126 Driver interface
128 Driver's signal
200 Sensor device
202 Combined sensor signal
204 Optimization device
206 Decoding device
210 Priority manager
212 Steering actuator
214 Brake actuator
216 Chassis actuator
218 Environment registering device
220 Switch
222 Temperature sensor
224 Rain sensor
226 ADAS Domain
300 Steering wheel
301 Accelerator pedal
302 Power connection
303 Energy supply device
306 Damper actuator
310, 311, 312 Other domains
314 Cloud
400 Microprocessor
402 Security unit
404 Energy supply interfaces
408 Standing supply device
410 Energy supply logic
412 Control element
414 Further security unit
416 Safety device
500 Method for operating a control unit
502 Step of receiving sensor signals
504 Step of receiving a trajectory signal
506 Step of emitting actuator signals
508 Step of determining actuator signals

1. A control unit (102) for a vehicle (100), comprising:
a movement module (104) configured for controlling a movement of the vehicle (100), wherein the movement module (102) is in the form of a first domain,
a sensor interface (106) configured for receiving sensor signals (108);
a trajectory interface (110) configured for receiving a trajectory signal (112) that represents a trajectory of the vehicle (100);
an actuator interface (114) configured for emitting actuator signals (116) for the control of actuators (118);
a determination device (120) configured for determining the actuator signals (116) using the sensor signals (108) and the trajectory signal (112); and
a further module (122), which is in the form of a further domain and is connected via a domain interface (124) with the first domain.

2. The control unit (102) according to claim 1, comprising an electronic circuit configured to provide both a functionality of the determination device (120) and also a functionality of the further module (122).

3. The control unit (102) according to claim 1, wherein the movement module (104) comprises a driver interface (126) configured for receiving a driver's signal (128) for controlling the actuators (118) and a priority manager (210) configured to send either the actuator signals (116) or the driver's signal (128) to the actuator interface (114).

4. The control unit (102) according to claim 1, wherein the sensor interface (106) is configured to receive the sensor signals (108) from an environment registration device (218), a switch (220), a temperature sensor (222), a rain sensor (224), a sensor of a steering actuator (212), a sensor of a brake actuator (214) and/or a sensor of a chassis actuator (212).

5. The control unit (102) according to claim 4, wherein the actuator interface (114) is configured to transmit the actuator signals (116) to the steering actuator (212), the brake actuator (214) and/or the chassis actuator (216).

6. The control unit (102) according to claim 1, wherein the determination device (120) comprises:
a sensor device (200) configured for determining a combined sensor signal (202) from the sensor signals (108);
an optimization device (204) configured for determining an optimized trajectory signal (206) from the trajectory signal (112) and the combined sensor signal (202); and
a decoding device (208) for determining the actuator signal (116) from the optimized trajectory signal (206).

7. The control unit (102) according to claim 6, wherein the sensor device (200), the optimization device (204) and the decoding device (208) are made with redundancy.

8. The control unit (102) according to claim 1, wherein the determination device (120) is realized using redundant microprocessors (400).

9. The control unit (102) according to claim 1, wherein the control unit (102) comprises:
two redundant energy supply interfaces (402); and
an energy supply device (302) configured for supplying the movement module (104) with energy from at least one of the redundant energy supply interfaces (402).

10. The control unit (102) according to claim 1, wherein the control unit (102) comprises a standing supply device (408) configured to deactivate part of the movement module (104) when the vehicle (100) is at rest.

11. The control unit (102) according to claim 1, wherein the control unit (102) comprises a safety device (416) connected to the sensor interface (106), the determination device (120), and the actuator interface (114).

12. A method (500) for controlling a vehicle (100), wherein the method (500) includes the following steps:
receiving (502) sensor signals (108) via a first domain;
receiving (504) a trajectory signal (112) that represents a trajectory of the vehicle (100) via the first domain;
determining (506) actuator signals (116) using the sensor signals (108) and the trajectory signal (112) within the first domain; and
emitting (508) actuator signals (116) for the control of actuators (118) via the first domain.
